(19) United States
(12) Patent Application Publication
(10) Pub. No.: US 2009/0049956 A1
(43) Pub. Date: Feb. 26, 2009

(54) Wrist-actuated beverage-container opener

(76) Inventor: Michael A. Brennan, San Diego, CA (US)

Correspondence Address: MICHAEL A. BRENNAN, 3895 (#M206) COLINA DORADA, SAN DIEGO, CA, 92124, US

(21) Appl. No.: 11/895,298

(22) Filed: Aug. 24, 2007

(51) Int. Cl. B67B 7/16

(52) U.S. Cl. 81/3.57

(57) ABSTRACT

Useful by both individuals and bartending ‘mixologists’, a convenient beverage-bottle cap pry-opener is adapted to user's wrist, thereby facilitating a uniquely simple and ergonomically comfortable wrist-twist action by which to attain quick and easy opening without use of one's hands; and is portably worn upon the person in the form of either a bracelet or glovelet embodiment. The glovelet is preferably of conventional open-fingered style, having an integral wrist-band thereto which wraps around the wrist where it is secured via conventional hook-&-loop fastener; while arranged at the distal-end of the wrist-strap is a substantially conventional metal bottle-cap opener device. The low-profile cap-opener lays generally unseen along the underside of the wearer's wrist, where it is at the ready; for example while holding the beverage-bottle vertically in the left-hand, the user merely rests their right-wrist over the bottle-cap, engaging the prying-edge under the cap's crimped-rim, merely exerts an approximate 45-degree wrist-rotation action, whereby the cap is released from the bottle, and is at once caught by the magnetized body of the ferrous-metal opener. The light-weight pry-opener device preferably includes a slightly arched trailing-end so as to thereby curve partially around the outer-side of one's wrist as to thereby lend additional anti-torquing stability. An optional feature offered by the pry-opener, is its adaptation with a novel prying-tip, which similarly acts to open conventional beverage-can pull-tabs via wrist-rotation action.

### I.) BACKGROUND OF THE INVENTION

1. Field of Invention

This invention disclosure relates to beverage container opening tools, and more specifically it relates to those types of hook & fulcrum bottle openers, operating in cooperation with user's wrist action.

2. Relevant Prior-Art

Background research discovery provides some prior patent-art regarded as germane to this disclosure, chronologically for example U.S. Pat. No. 4,414,692(filed: June, 1982) shows a so-called ‘drinking-glove’ in combination with a ‘bottle or cup wrapping-sleeve’, wherein the two respective attaching/detaching members include mating hook-&-loop (ie—Velcro®) type fastening means. This ensemble thus enables its user to hold a very cold(or hot) container without discomfort; and all the individual thumb and finger tubules of the glove beyond one's knuckles are eliminated, while the wrapping-sleeve also employs Velcro® as to enable adapting to the circumference of different drinking vessels. However, no wrist-action opener means is contemplated.

In U.S. Pat. No. 4,447,912 (filed: February, 1983) is shown a another abbreviated style glove, this one being fitted with various palm-pockets enabling a hand-disabled person to adapt it to use of various devices, such as a toothbrush, pencil, bottle-opener, etc.; the glove being formed around and secured upon ones hand by means of integral hook-&-loop strap fasteners. However, no wrist-action opener means is contemplated.

In U.S. Pat. No. 4,805,238 (filed: December, 1987) is shown a further abbreviated style glove/mitt for a ‘bartending mixologist’, which primarily covers the palm region of their hand, and whereto is integrally adapted a multi-splined or circular-toothed female-cavity like tool configured as to readily engage upon the top of ‘twist-off’ type bottle-caps,—upon exertion of an initial twisting-motion of their hand-&-arm. However, no wrist axial-rotation twisting action is contemplated.

In U.S. Pat. No. 5,133,233 (filed: September, 1991) is shown another fingerless glove adapted at its central palm-region with an integral hook-&-fulcrum type leverage opening device, whilst the glove/mitt is configured with only a thumb-aperture, whereby the mitt is wrapped over the back of the hand and secured via hook-&-loop type fasteners. However, forward-rocking (fingers deploying downwardly) action of the mitt is employed; therefore no wrist axial-rotation action was employed.

In U.S. Pat. No. 5,261,299 (filed: November, 1992) is shown another semi-mitt like hand-accessory is adapted at its palm-region with a conventional elongate bottle-opener device which extends outward slightly past the thumb-crutch space between thumb and forefinger; therefore required a forward-tipping action of the hand and forearm, thus no wrist axial-rotation twisting action is contemplated.

In U.S. Pat. No. 5,276,922 (filed: August, 1992) is shown another open-fingered glove employing a transversely oriented (ie: from heel of palm toward thumb-crutch) conventional elongate bottle-opener device which requires an awkward unnatural thumb-dipping motion of the wrist, inviting carpal-tunnel syndrome action to flip-open a bottle-cap of the mechanically multi-crimped type; hence, no advantageous ‘thumb-rising’ motion is employed.

In U.S. Pat. No. 5,329,832 (filed: November, 1993) is shown a forefinger-sleeve mounted device in the form of a rigid snag-hook, which the user engages into the ring-aperture of a conventional beverage-can pull-tab, whereby the pull-tab device may be opened without actually grasping the pull-tab as is customarily done.

In U.S. Pat. No. 6,098,497 (filed: February, 1999) is shown a combination wrist-watch and encircling bottle-opener device, employing a conventional hook-&-loop wrist-band in combination with a female-bezel having inwardly opposed serrated-teeth capable of indexing upon the top of a conventional multi-crimped type twist-off bottle-cap. Hence, no wrist axial-rotation twisting action is contemplated.

In U.S. Pat. No. 6,709,125 (filed: July, 2002) is shown an elongate tubular hand-tool having a flattened slot-like mouth at its operating terminus, whereby the mouth is slid radially upon the cantilevered end of a conventional beverage-can pull-tab, and then the tool is merely leveraged upward to open the pull-tab without need to grasp with one's fingers.

Therefore, in full consideration of the preceding patent review, there is determined a need for an improved form of device to which these patents have been largely addressed. The instant inventor hereof believes their newly improved bottle-opener device, commercially referred to as the “Marinator™”, currently being developed for production under auspices of Syzygy-Enterprises exhibits certain advantages as shall be revealed in the following portion of this instant disclosure.

### II.) SUMMARY OF THE INVENTION

A.) in view of the foregoing discussion about the earlier invention art, it is therefore important to make it pellucid to others interested in the art that the primary object of this invention is to provide a bottle-opener adapted to a preferably opened-fingered (aka: fingerless) type of glove such as the sort often used by cyclists, wherein the finger-tubules and thumb-tubule are abbreviated at the knuckles. While cowhide is generally preferred, my Marinator™ glovelet (ie: defined herein as a drinking glove with or without finger covering tubules) can be made of imitation-leather, or other materials such as nylon/stretch-fabric clad frothed-neoprene material commonly used in marine wetsuit-gloves. The glove-body material option is however of minor consequence to the primary purpose, that of serving to enhance the function of my novel ‘wrist-action’ method of facilitating the convenient opening of beverage-bottles in a casual manner, a factor often regarded in the genera of the newly uninitiated younger set as—‘kool’.

My invention implements a thoughtfully human-engineered physical action of the human-wrist, which particular forearm axial-rotation has identified a critical factor in achieving a properly exercised “wrist-action bottle-opening procedure”. Properly implemented, my novel function obviates the dreaded CTS/‘carpal-tunnel syndrome’ problem, commonly identified with improper flexure of the ligaments extending through the wrist. By exemplifying usage upon one's right-forearm, employing my unique wrist-rotation action therefore begins with the hand in a pronated-position (ie: demonstrated by placing of one's hand palm-down upon a countertop), whereby it can be observed among persons with normally articulating forearm-joints, that one's forearm cooperative ulnar and radius-bones are rotated freely on its axis via pulling of the musculature at the elbow region, to rotate the distal wrist through a range of at least 90-degrees, to a point where one's right-hand becomes tilted upon its so-called ‘heel’-sector (that lateral portion of one's hand transversely at the extreme opposite of one's thumb) whereby one's thumb is thus extended upward!

This vital functional action is for the moment being focused upon, owing that in the earlier mentioned U.S. Pat. No. 5,276,922 for example, the inventor unwittingly failed to realize they had adopted a potentially debilitating direction of wrist-action, resulting in an awkward thumb-dipping action (opposite to that being set forth herein), which the human-wrist/forearm aggregation is not capable of comfortably accommodating; the referenced prior-art patent therefore potentially promoting dreaded stressful CTS, especially relative to RMI/‘repetitive-motion injury’.

B.) Another object of this invention disclosure is to set forth an ergonomic drinking glovelet article according to the particular wrist and forearm articulation described in my preceding item-A, which is very effectively facilitated via adaptation of a substantially conventional rigid metal hook-&-fulcrum (aka: indexer-&-fulcrum) type container-cap pry-opener device, which is preferably made of ferrous-steel which can thus be factory-magnetized so as to thereby cause a conventional ferrous-metal bottle-cap to become sufficiently attracted to the user's wrist upon prying off the cap from the bottle.

The substantially conventional cap-opener device is integrated in a desirably low-profile manner at the ready beneath the wearer's wrist. In order to stably resist the powerful wrist-torquing load momentarily imposed upon the lower perimeter-edge of a factory-sealed container-cap such as is typically provided upon a beverage bottle (ie: beer or soda-pop) for example, the built-in configuration of the pry-opener device structurally finds exceptional physical support via my hand-covering glovelet embodiment, in which the torsional-loads become efficiently absorbed owing the preferred intimate fitting of the glovelet body to its user's hand (ie:—that is to say, that a loose fitting glovelet would tend to allow the integral cap-opener device to problematically shift position during axial-rotation of the wrist, and tends toward lifting away from the wrist.

Thus there are actually four iterations being set forth herein, the first version being the basic glovelet embodiment, to which is integrated the cap-opener device. The second version generic-variant embodiment employs a lateral wrist-wrapping strap made permanently dependent from the glovelet body, while holding the cap-opener device at its distal-terminus. In the third embodiment of this invention disclosure, the strap portion is made detachable from the glovelet body, so as to thereby be worn alone around one's wrist if desired,—without the glovelet body portion. The fourth embodiment of my ergonomic wrist-action cap-opener invention, is a wrist-wrapping ‘bracelet’ alone, which may be used while affixed to one's wrist, similar to the manner as already described relative to the glovelet version; plus, the strap portion itself may be detached from the user's wrist, whereby deployment of the cap-opener may be executed by hand while remaining contegious with the resulting bracelet strap,—or, the cap-opener may be entirely removed from a retention-pocket of the strap if desired.

C.) Another object of this invention disclosure is to set forth ergonomic drinking glovelet or bracelet articles employing the novel wrist and forearm axial-rotation articulation according to my preceding items-A&B, in which a further optional improvement may be employed by the otherwise substantially conventional generally planar elongate cap-opener device herein adapted to my invention. This further improvement is described as an arched radiused-bend formed proximal the distal terminus of the generally planar elongated cap-opener device, which approximate right-angle radiused-bend serves to effectively extend the torsional-load impingement point against the user's outer-wrist region;—thereby substantially reinforcing the glovelet against torque of leverage-action sustained during the momentary cap-opening procedure. Furthermore, the effectiveness of this partial wrap-around of the wrist region by the rigid cap-opener, is found to be even more important in similarly stabilizing the generic variant ‘bracelet’ type embodiment of my invention disclosure hereof,—against adverse wrist slippage caused by torque-reaction during the cap-opening procedure.

D.) Another object of this invention disclosure is to set forth an ergonomic drinking glovelet or bracelet articles employing my novel wrist and forearm axial-rotation articulation according to my preceding items-A/B/C, in which still another improvement option may be implemented in the form of an additional preferably V-shaped terminus which entity is adapted proximal to, and in structural combination with, the otherwise substantially conventional cap-opener device; naturally only one of the adjacent openers can be engaged during any opening procedure. The interposed engaging terminus is preferably replete with a slightly chamfered underside at its tip, as to thereby enable the user to more readily engage the prying-tip into the receiving ‘pull-tab’ ring of a conventional beverage-can. Then once so engaged, by vigorous rotation of one's wrist, the outermost terminus of the pull-tab ring becomes leveraged-up sufficiently as to thereby press-down upon the opposite fracturable scored-tongue, and thus crack it open in the usual manner, biased beneath the thus exposed pouring-aperture. Whereupon, the wrist borne apparatus is disengaged, and the beverage is ready for drinking directly from the opened can as customary. As with conventional pry-opener devices, both of the container opening embodiments being set forth herein can be reused innumerable times without failure.

### III.) DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the claims section annexed hereto; and accordingly, a better understanding of the invention and the variant uses is intended, by reference to the drawings, which are considered as primarily exemplary and not to be therefore construed as restrictive in nature; wherein:

FIG. 1, is a semi-diagrammatic pictorial perspective-view of an open-fingered right-hand glovelet embodiment's underside (aka: front-side), showing the relative positioning of the integrated pry-opener device, whereto a partial cutaway of the wrist reveals arrangement of the closure-flap portion, while accordingly the unshown left-hand iteration would be a mirror-image thereof owing to requirement for the left-hand operation be be in an opposite counter-clockwise manner;

FIG. 2, is a diagrammatic X-ray like bottom-view showing the right wrist's carpal-region in relationship to the forearm's longitudinally joining ulna and radius bones;

FIG. 3, is a diagrammatic transverse cross-sectional elevation-view of a human's right-wrist, showing the degree of clockwise(CW) axial-rotation which is generally obtainable from the horizontally pronated position, noting that counter-clockwise axial-rotation is not demonstrated owing that C-CW rotation beyond the pronated wrist position is antagonistic to the carpal-region nerves;

FIG. 4A, is a semi-diagrammatic cross-sectional elevation-view graphically demonstrating my ergonomic wrist-action pry-opener principle, which is projected along the longitudinal-axis of the user's forearm/wrist according to FIG. 3, showing how the wrist-integrated conventional cap-opener device is initially engaged relative to a conventional bottle-cap via novel application of user's wrist as eluded to in FIG. 1 (note: uniting glovelet/bracelet body portions are omitted for sake of visual clarity);

FIG. 4B, is a slightly reduced second-sequence thereof, wherein is demonstrated the final degree of axial-rotation generally employed to attain mechanically pried release of a conventional factory crimped-on bottle-cap;

FIG. 5A, presented in a manner familiar to FIG. 4A, is a transverse semi-diagrammatic elevation-view of my ergonomic writs-action tab-opener projected along the longitudinal-axis of the user's forearm/wrist according to FIG. 3, and showing how the integrally formed tab-opener device is initially engaged relative to the pull-tab ring of a conventional beverage-can via novel application of user's wrist thereto (note: uniting glovelet/bracelet portions omitted for sake of visual clarity);

FIG. 5B, is a slightly educed second-sequence thereof, demonstrating the final degree of axial-rotation generally employed to attain mechanical-opening of an entirely conventional factory-sealed beverage-can pull-tab and associated factory-scored tongue;

FIG. 6, is a semi-diagrammatic pictorial perspective-view favoring the upper-left (aka: back-side) afterward region of a full-fingered glovelet embodiment, which wrist-strap is shown opened, revealing the relative positioning of the integrated pry-opener device (shown via phantom outline);

FIG. 7, is a semi-diagrammatic transverse elevation-view projected along the wrist/forearm longitudinal-axis at the wrist region (the wrist cross-section of FIG. 4 having been omitted as to thereby show my invention only), thus revealing the general wrist-wrapping construction of the optional extended strap configuration of the glovelet embodiment, and including a partially separated portion of the strap as to better reveal how the extended strap portion may be deployed;

FIG. 8, is a semi-diagrammatic transverse elevation-view projected along the wrist/forearm longitudinal-axis at the wrist region (the wrist cross-section of FIG. 4 having been omitted as to thereby show my invention only), thus revealing my general wrist-wrapping glovelet in further combination with my bracelet, wherein the strap is shown partially detached from the glovelet portion, and whereto it is explained that the bracelet portion may be employed separately around one's wrist.

### IV.) ITEMIZED NOMENCLATURE INDICIA REFERENCES

10,10′,10″,10C,10W—human hand, thumb, finger(s), wrist (cross-section), wrist (region)
11—longitudinal-axis of wrist/forearm
12,12′,12″,12R—ulna-bone, radius-bone, epidermis, clockwise rotation action ref.-arrow
13,13′,13″,13A,13R—overall pry-opener device, leading-end, trailing-end, arch, rivet
14,14′,14″—cap-opener: prying-edge, fulcrum-edge, relief-aperture
15,15′,15″—tab-opener: prying-tip, chamfer (taper), fulcrum-point
16,16W,16S,16′/16″—Glovelet: body, wrist-covering, relief-slit, fastener (hooks/loops)
17,17′,17″17C—strap: flap version, extended version, distal-terminus, connection
18,18′,18″—Bracelet: strap, inward-end, outward-end
19,19′,19″,19T,19C,19S—bottle, chime, cap, cap top, crimping-rim, crimped scallop
20,20′,20″,20M—beverage-can, can-top chime, tongue, mouth
21,21′,21″,21A—pull-tab, ringlet, ringlet-aperture, rocking-action ref.-arrow

### V.) DETAILED DESCRIPTION OF THE PREFERRED EMBODIMENTS

Initial reference is given by way of FIG. 1, wherein is exhibited a human-hand 10 and wrist 10″ in a thumb up attitude, whereto a minimalized version of my basic glovelet embodiment is exhibited, which is open-fingered (including thumb 10′) and has no encircling wrist-wrapping strap; and whereto is indicated longitudinal-axis 11 of the wrist and forearm aggregation; only a hand ingress/egress relief-slit 16S shown here closed via an overlapping abbreviated strap like flap 17 having a conventional connection 17C or closure preferably of the well known hook-&-loop type (Velcro® providing the advantage over snaps of finite adjustability to ones wrist circumference). This underside view of the hand and wrist, also reveals the preferably semi-exposed pry-opener 13, which leading-end 13′ portion is optionally secured to the glovelet's flexible wrist-extension structural material via a small rivet 13R, so as to thereby in some configurations better resist the substantial prying load which wants to pull the pry-opener away from its intimate low-profile position proximal the wrist as shown. The trailing-end 13″ of the pry-opener is preferably fully enveloped (ie—inside and outside) by wrist region flexile structure of the glovelet or bracelet material.

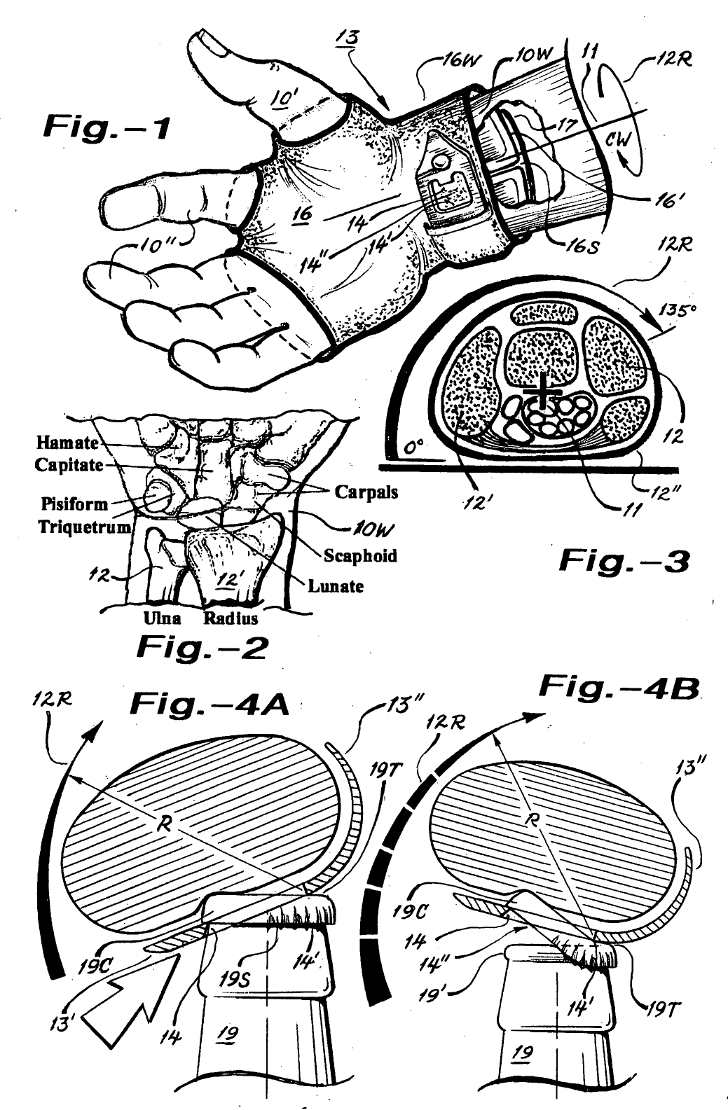

Reference to FIG. 2 shows the various intricate complex of bones which comprise the wrist region, while adjacent FIG. 3 serves to demonstrate the vital axial-rotation function (see ref.-arrow 12R in FIGS. 1 & 3) facilitated primarily by one's ulna-bone 12 and cooperative radius-bone 12′ (which are actuated via unshown musculature of one's forearm and upper-arm region. This structure of the human-body is being focused upon here, as to more clearly demonstrate how my invention uniquely relies upon the clockwise axial-rotation of the wrist/forearm in order to perform its novel container pry-opening capability;—a physical aspect which most of us never have a need to contemplate.

Study of FIGS. 4A/4B reveals exactly how my wrist-action cap-opener is initially tilted down only slightly as to be engaged via its prying-edge 14 impinging directly upward beneath the crimping-rim 19C encircling the chime 19′ of a conventional bottle-cap 19″, whilst at the same time the fulcrum-edge 14″ is impinged downward upon the cap's opposite top surface 19T; whereupon the user merely exerts a determined approximate 30-45 degree clockwise axial-rotation (per FIG. 3) of their wrist/forearm until the bottle-cap 19″ becomes mechanically pryed from the bottle-chime 19′. Note that the prying-edge 14 may be variously formed (such as by a straight or arched transverse edge, or via a tooth like formation indicated), the only essential requsite being that it be so configured as to be capable of engaging beneath one to several of the shown encircling crimping-rim 19C scallops 19S which serve to grip tightly upon the bottle-chime 19′.

Similarly, in FIGS. 5A/B is shown an optional alternate beverage-can pop-top type pry-opener device formed as an alternate leading-end extension terminus of the primary pry-opener device revealed in FIG. 1. In FIG. 5A however, while the wrist-action is essentially the same, the bottle-cap opening portions 14′ and 14″ are not utilized; instead, while holding the beverage-can vertically in their opposite hand, the preferably V-shaped integrally-formed prong like prying-tip 15 is aimed downward slightly while inserted (action ref.-arrow 21A) steadily into ringlet-aperture 20″ of the conventional pull-tab 21, whereupon the user commences to exert a determined clockwise axial-rotation 12R (counter-clockwise for left-handed embodiment) as is further demonstrated in FIG. 5B, wherein the trailing-end 13″ of the pry-opener's elongate-body becomes impinged upon the can's top or chime portion 19′, at thereby establishing a fulcrum point 15″, whereupon the pull-tab 21 becomes forcibly pried-up sufficiently as to thereby rock-down (action ref.-arrow 21A) the opposite-end of the pull-tab upon the fracturable factory scored-tongue 20″ causing a resounding ‘cracking open’ of the mouth 20M in the well known conventional manner;—whereupon the pry-opener is disengaged and the contained libation may be partaken of without requiring usual manipulation by one's thumb & index-finger.

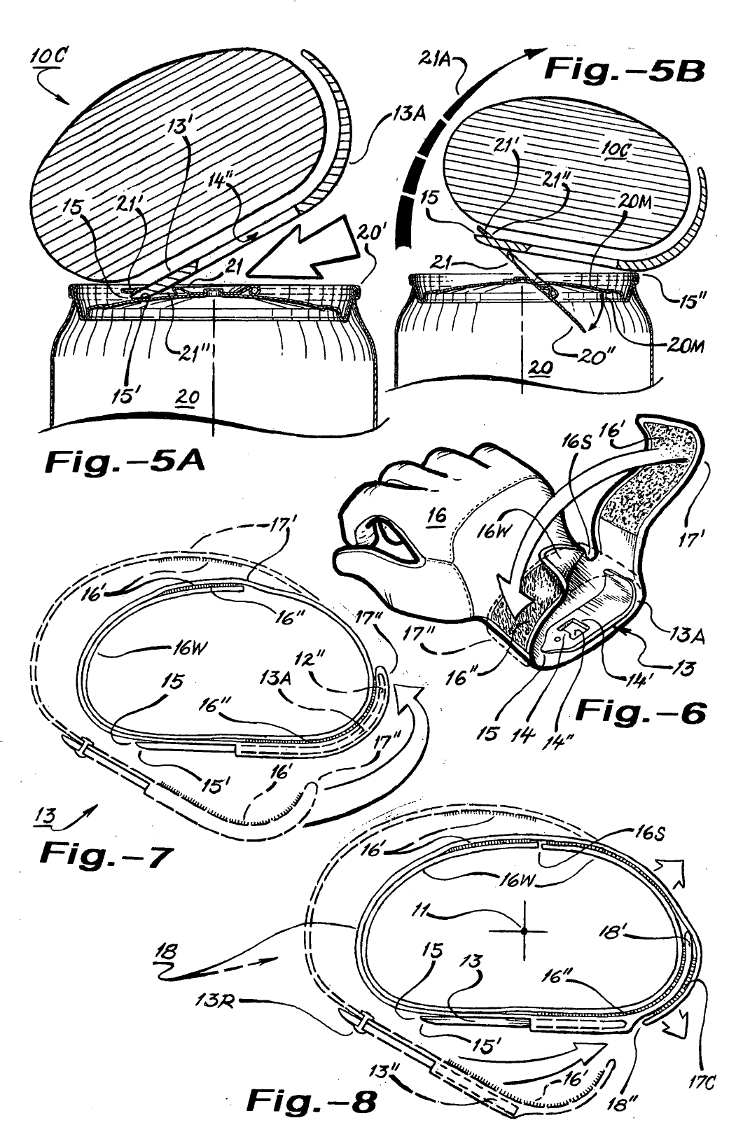

There remain subtle, however important other differences which are to become herein more evident and understood as important improvements. For example, the full-fingered glovelet embodiment of FIG. 6 shows how a short strap or flap 17 and relief-slit 16S embodiment may be employed to primarily facilitate quick and easy hand ingress/egress relative to the glovelet body 16. Such an arrangement is preferably provided in combination with conventional fastener means such as ordinary hook-&-loop (aka: Velcro®) avulsable fastener 16′ and 16″ (or substantially equivalent male-&-female snap-fasteners). In FIG. 6 (as in FIG. 1) embodiment, the overall pry-opener device 13 is shown fully integrated fixed into the wrist-covering extension body of the glovelet; while in the generic-variant embodiment of FIG. 7, the same substantially conventional pry-opener 13 is shown with the arched 13A portion which wraps outward laterally upward so as to better embrace the outer lateral portion of user's wrist.via distal terminus 17″ portion of the more elongated extended wrist-wrap strap 17′, also preferably having a conventional fastener 16′/16″ at its outer-terminus.

Another generic-variant embodiment of my invention is the ‘bracelet’ configuration of FIG. 81 comprised of elongated strap 18, with so-called inward-end 18′ and outward-end 18″; thereby enabling it to be used alone entirely separate from the glovelet's shown wrist-covering portion 16W if desired. Note also the pry-opener device 13 shown in FIG. 8 is of more conventional abbreviated planar configuration, remiss of optional arched 13A portion shown in FIG 7. A further variant embodiment of FIG. 8 shows an additional connection 17C, which enables user to entirely detach the bracelet via to an optional mating Velcro®-type fastener provided upon the glovelet's wrist-covering portion 16W. Accordingly, this final iteration would represent the most overall versatile embodiment of my wrist-action beverage-container opener, owing that it may be used according to the glovelet constituent features set forth herein, or optionally, as a minimal discrete bracelet alone; and which may even be uncoupled from the user's wrist, forearm, or ankle, and deployed separately if the end having the pry-opener is merely held in user's hand in a more conventional manner not involving axial-rotation of the wrist.

Thus, it is readily understood how the preferred and generic-variant embodiments of this invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, the invention has been disclosed herein by way of example, and not as imposed limitation, while the appended Claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is claimed, are defined as follows.

What is claimed of proprietary inventive origin is:

1. An ergonomic wrist-action beverage-bottle cap-opener apparatus; comprising:
a substantially conventional elongate rigid pry-opener of the indexer-&-fulcrum type adapted transversely beneath one's wrist in combination with a wrist encircling flexile mounting means, with securing means thereto attached/detached by wearer's other hand.

2. The ergonomic cap-opener apparatus according to claim-1, wherein said combination enables wearer to free-handedly position pry-opener atop a factory installed bottle-cap, and upon engaging the indexer-edge portion directly beneath the cap crimping-rim as the fulcrum-edge portion is impinging atop the cap, whilst beverage-bottle is held substantially vertical in one's other hand, user physically exerts a clockwise axial-rotation of their wrist/forearm as to effectively translate their thumb from horizontal toward vertical orientation, thereby attaining quick and easy release of the bottle-cap.

3. The ergonomic cap-opener apparatus according to claim-1, wherein said pry-opener's elongated body terminates with an upwardly arched bend, serving to extend the impingement point against user's outer-wrist region, thereby providing greater resistance to torque of leverage-action sustained during cap-opening procedure.

4. The ergonomic cap-opener apparatus according to claim-1, wherein said pry-opener is made of a factory magnetized ferrous-metal, thereby facilitating convenient automatic retention of a once opened ferrous-metal bottle-cap.

5. The ergonomic cap-opener apparatus according to claim-1, wherein said wrist encircling mounting means is a flexile conventional glovelet body including an integral wrist-covering portion having longitudinal-split opening and closure means for accommodating hand ingress/egress.

6. The ergonomic cap-opener glovelet according to claim-5, wherein said closure means is via conventional hook-&-loop avulsable overlapping-flap portion.

7. The ergonomic cap-opener glovelet according to claim-5, wherein said glovelet may be configured with or without thumb and finger appendages according to factory engineering-design choice.

8. The ergonomic cap-opener apparatus according to claim-1, wherein said wrist encircling mounting means employs a transverse wrist-wrapping strap means holding the pry-opener at its outer terminus whilst stowed beneath the wrist; and may also alternately be deployable unwound dependent from said glovelet for optional hand-held opening of a container-cap.

9. The ergonomic cap-opener apparatus according to claim-8, wherein said wrist wrapping strap means includes a conventional detachable fastening means, enabling pry-opener to be used by either hand entirely separate from said glovelet portion.

10. The ergonomic cap-opener apparatus according to claim-1, wherein said wrist encircling mounting means is a bracelet like embodiment comprising a transversely wrist-wrapping strap means holding the pry-opener at its outer terminus, and configured whereby the pry-opener is stowed in a low-profile manner proximal underside of wearer's wrist where said securing means is stayed.

11. The ergonomic cap-opener apparatus according to claim-10, wherein said securing means is a conventional hook-&-loop type avulsable type fastener.

12. The ergonomic cap-opener apparatus according to claim-1, wherein said pry-opener's inboard-terminus is configured with a prong like prying-tip for engaging into the ringlet portion of a beverage-can's conventional pull-tab while the opposite outboard portion of the pry-opener impinges as a fulcrum-point upon the top of the beverage-can; whereupon via clockwise axial-rotation of one's wrist/forearm the ringlet portion becomes snagged and leveraged-up whilst thereby causing the opposite-end of the pull-tab to thus conventionally rock-down upon the fracturable scored-tongue and crack it open in well known manner.

13. The ergonomic pull-tab opener according to claim-12, wherein underside of said prong like prying-tip is chamfered, resulting tapered shape thereby enabling said prying-tip to be inserted more easily at an oblique-angle into the ringlet's aperture.

14. An ergonomic wrist-action bottle-cap opener passively carried upon user; said apparatus comprising: a flexile wrist encircling mounting means having longitudinal-split opening hand ingress/egress means with closure means thereto, including a substantial conventional rigid elongate indexer-&-fulcrum type pry-opener formed with an upwardly arched outboard terminus, integrated in a low-profile manner at the ready beneath users wrist, enabling wearer to engage said pry-opener and exert wrist axial-rotation means as to thereby attain quick and easy free-handed release of a conventional container-cap.

15. The ergonomic opener according to claim-14, wherein said wrist axial-rotation means is the implementation of user's wrist at a substantially horizontal attitude whilst the unopened container is held vertical in user's opposite hand, whereupon with indexer engaged laterally beneath crimped-rim of bottle-cap, whilst fulcrum-edge portion impinges atop the cap, whereby user axially-rotates their wrist/forearm which effectively raises their thumb from the horizontal toward a vertical orientation.

16. The ergonomic opener according to claim-14, wherein said pry-opener is made of a factory magnetized ferrous-metal, thereby facilitating convenient automatic retention of the once opened ferrous-metal bottle-cap.

17. The ergonomic opener according to claim-14, wherein said closure means is via conventional hook-&-loop avulsable device.

18. The ergonomic opener according to claim-14, wherein said pry-opener's inboard-terminus is configured with a prong like prying-tip for engaging into the ringlet portion of a beverage-can's conventional pull-tab while the opposite outboard portion of the pry-opener impinges as a fulcrum-point upon the top of the beverage-can; whereupon via clockwise axial-rotation of one's wrist/forearm the ringlet portion becomes snagged and leveraged-up whilst thereby causing the opposite-end of the pull-tab to thus conventionally rock-down upon the fracturable scored-tongue and crack it open in well known manner.

19. The ergonomic opener according to claim-14, wherein underside of said prong like prying-tip is chamfered, resulting tapered shape thereby enabling said prying-tip to be inserted more easily at an oblique-angle into the ringlet's aperture.

20. A method of employing a dual-modality wrist portable ergonomic beverage bottle-cap pry-opener apparatus, said method comprising:
providing a flexile conventional glovelet mounting means with a longitudinal-split opening means for hand ingress/egress including closure means thereto, plus an integral wrist-wrap strap portion formed contiguous thereto having a proximal-end and a distal-end;
providing a conventional rigid indexer-&-fulcrum type cap-opener at said distal-end of said strap portion, whereby one wrap-around places said cap-opener at the ready beneath users wrist, enabling wearer to engage said cap-opener and exert wrist/forearm axial-rotation action, as to thereby attain quick and easy free-handed release of a conventional bottle-cap;
providing detachable means at said proximal-end of said wrist-wrap strap member relative to said glovelet, thereby enabling user the option of carrying the cap-opener via the wrist-wrap strap alone; whilst still employing the same novel said wrist-action cap-opening procedure.
